(19) United States
(12) Patent Application Publication
(10) Pub. No.: US 2010/0131090 A1
(43) Pub. Date: May 27, 2010

(54) METHOD AND PROCESS FOR AUTOMATING THE DESIGN OF A LOCKING MECHANISM FOR A HEARING INSTRUMENT

(75) Inventors: Fred McBagonluri, East Windsor, NJ (US); David McAvoy, Manasquan, NJ (US)

Correspondence Address: SIEMENS CORPORATION;INTELLECTUAL PROPERTY DEPARTMENT, 170 WOOD AVENUE SOUTH, ISELIN, NJ, 08830, US

(73) Assignee: Siemens Hearing Instruments, Inc., Piscataway, NJ (US)

(21) Appl. No.: 12/275,460

(22) Filed: Nov. 21, 2008

(51) Int. Cl. G06F 19/00

(52) U.S. Cl. 700/98

(57) ABSTRACT

In a method for automating design of a locking mechanism for a hearing instrument, a computerized 3D file of an ear impression shell surface is provided based on a 3D scan of a 3D ear impression of a patient's ear. The ear impression shell surface includes a locking surface comprising at least one of a helix or canal concha portion of the patient's ear. A 3D file is provided of a hearing aid shell. With a computer, the hearing aid shell is placed in a desired location in the ear impression shell surface where the hearing aid shell is to be locked in position. With the computer, a volume surface as a 3D file is created representing the locking mechanism by utilizing a profile of the ear impression shell surface to be used as the locking surface. The volume surface runs from the ear impression shell surface and along the profile of the locking surface.

### BACKGROUND

The present preferred embodiments are directed to a method and process for the automation of the design of a retention locking mechanism for a hearing instrument (hearing aid) that results in a monolithic shell and prevents the instrument from being displaced during normal daily activities, including talking, chewing and exercise.

Recent advances in computer-aided design for a hearing instrument have significantly increased both quality and efficiency in the hearing instrument design. However, these gains and the transition from an inherently manual process into software have resulted in significant changes in the design of the hearing instrument retention locking mechanism, such as canal locks and helix locks.

While advanced electro-acoustic hardware and software systems currently pervade the hearing industry, the ability to comfortably sustain hearing instruments in a patient's ear still combines both art and science. Some of the utilized technologies that are considered include sound differentiation, speech intelligibility, binaural synchronization, adaptive sound smoothing, etc.

But the most sophisticated hardware systems are worthless unless the customer can derive tangible benefits from them by actually wearing the hearing devices that utilize the sophisticated systems. Customers are more likely to wear hearing aids if they include such features as snuggle fit, effective occlusion, absence of excessive soreness, speech intelligibility, environmental adaptability, etc. Significant technological advancement in hearing instruments is only possible when there is a stringent handshake between hardware and software systems acting in tandem, as well as factors that take into account comfort and ease of use that ensure users are more likely to utilize the hearing devices.

The technology to mass custom manufacture hearing instrument casings is also driven in part by the desire to industrialize and automate manufacturing and to take advantage of throughput, consistency, quality improvements, and timely replication.

Prior to computer-aided design and manufacturing of hearing instrument systems, a person who interacted with the customer (a “dispenser”) took a physical impression (mold) of the patient's ear canal and collected pertinent audiological information. This information was then mailed to a hearing aid manufacturing factory for a custom instrument design.

With the advent of electronic ordering systems, the dispenser now has the advantage of scanning the mold and then filing out an electronic order form, which is then transferred to the factory. The intention of the electronic ordering process is to ensure timeliness and accuracy of the order delivery protocols and to enhance customer-factory interaction, thus improving both product quality as well as turnaround time.

This otherwise straightforward technology is still plagued with challenges. Pertinent among these are the lack of the technological wherewithal to adapt all the current manual design processes into software so that the dispenser only sends an electronic model of an impression (e.g., as a point cloud).

Certain hearing aid shells (casings) require retention locking mechanisms to hold the instrument in the customer ears. These mechanisms, which are usually manually glued to the shell, include a helix lock or a canal lock. The helix lock and canal lock involve an additional solid element that serves as an extra contact point along the outer ear (“helix”) and ear canal concha region (“canal”) respectively, relating to those portions of the ear. This serves to hold the hearing aid in place in the canal by hinging on the helix or the concha region of the ear canal.

In current implementations, certain shell types, including those with helix and canal locks, require that the dispenser sends both the physical and electronic impressions. This is because in order to design a canal or helix lock, the factory has to be able to generate a secondary mold (a negative cast) of the canal or helix from the physical impression using manual techniques. This is necessary because currently this mold cannot be generated from the physical impression.

These techniques require that this negative cast be created from the helix section of the impression. The resulting mold is manually sculptured and shaped along the patient's helix. The final instrument is then assembled after sintering by merging the final designed shell and the physically sculptured canal or helix lock. This design hybridization approach renders the electronic processing of such instruments cumbersome and includes laborious multiple-processing steps.

Furthermore, there is a high propensity for such instruments, which are generally held together by glue, to dislocate during in-service use. Additionally, with the introduction of monolithic instrument casing, where the faceplate is sintered as part of the physical shells, it would be very advantageous to have a computerized assembly of the canal and helix lock systems.

With the advent of rapid prototyping technologies, it is currently impossible to create the retention and locking mechanism to custom mass produce hearing instruments with instruments with custom or customer specific retention features.

### SUMMARY

In a method for automating design of a locking mechanism for a hearing instrument, a computerized 3D file of an ear impression shell surface is provided based on a 3D scan of a 3D ear impression of a patient's ear. The ear impression shell surface includes a locking surface comprising at least one of a helix or canal concha portion of the patient's ear. A 3D file is provided of a hearing aid shell. With a computer, the hearing aid shell is placed in a desired location in the ear impression shell surface where the hearing aid shell is to be locked in position. With the computer, a volume surface as a 3D file is created representing the locking mechanism by utilizing a profile of the ear impression shell surface to be used as the locking surface. The volume surface runs from the ear impression shell surface and along the profile of the locking surface.

### BRIEF DESCRIPTION OF THE DRAWINGS

FIG. 1 is a cross-sectional illustration of a hearing aid shell in a first embodiment of the method of the invention in which an elliptic profile has been generated and can be extruded to create the locking mechanism along a profile defined along the helix portion or concha region canal portion of an ear impression profile shell surface;

FIG. 2 is an illustration of the hearing aid shell of FIG. 1 in which two elliptic profiles (13A and 13B of FIG. 2) have been generated and are lofted along the ear impression shell surface profile to create the locking mechanism;

FIG. 3 is an illustration of the hearing aid shell of FIG. 1 in which multiple elliptic profiles (13A-13C of FIG. 3) have been generated and are lofted together along the ear impression shell surface profile to generate the locking mechanism;

FIG. 4 is a perspective illustration for a second embodiment of the method of the invention of a triangulated external shell surface of the ear impression (also known as a cast of the ear impression or an external ear impression hereafter) where a portion of the shell surface at the top has been cut away for ease of viewing;

FIG. 5 is a perspective illustration of the ear impression shell surface of FIG. 4 with a detailed hearing aid instrument shell registered together, the external ear impression shell surface serving as a reference cast and providing a profile defined by a locking surface such as the canal or helix regions for generating the locking mechanism;

FIG. 6 is a perspective illustration of the ear impression shell surface of FIG. 4 with the locking mechanism attached to a surface of the hearing aid shell;

FIG. 7 is a perspective illustration of the ear impression shell surface of FIG. 4 with the locking mechanism undergoing a bending operation along a profile of the ear impression shell surface (cast);

FIG. 8 is a perspective illustration of the ear impression shell surface of FIG. 4 with the locking mechanism undergoing an extension operation along the profile of the ear impression shell surface (cast);

FIG. 9 is a perspective illustration of the ear impression shell surface of FIG. 4 with the locking mechanism undergoing a stretching operation along the profile of the ear impression shell surface (cast); and

FIG. 10 is a perspective illustration of the finalized hearing instrument shell with details added in the ear impression shell surface of FIG. 4 with the locking mechanism attached to the hearing instrument shell.

### DESCRIPTION OF THE PREFERRED EMBODIMENTS

For the purposes of promoting an understanding of the principles of the invention, reference will now be made to the preferred embodiments/best mode illustrated in the drawings and specific language will be used to describe the same. It will nevertheless be understood that no limitation of the scope of the invention is thereby intended, and such alterations and further modifications in the illustrated device and such further applications of the principles of the invention as illustrated as would normally occur to one skilled in the art to which the invention related are included.

The present preferred first and second embodiments are directed to a method and process for generating electronically a retention locking mechanism in a hearing instrument shell surface resulting in the manufacturing of a monolithic shell using two geometric modeling techniques and hence facilitating mass custom production of tenable hearing instrument systems. The technique includes creating a volumetric model (also known hereafter as a “volume surface”) of the retention locking mechanism along a natural profile to be used as a locking surface, such as the ear helix region or concha region of an ear impression shell surface, and the integration of the generated locking mechanism using a Boolean operation to attach the locking mechanism to the locking surface of the hearing instrument shell.

Shell modeling requires the triangulation of a point cloud system, which is X, Y, Z data acquired from a 3D scanning of a customer earmold. The resulting ear impression shell surface is a surface triangulation of point set data obtained from scanning the physical ear impression. Triangulation is a well-known prior art technique involving a connecting of the closest optimal three points for creating a solid surface. The geometric file formats of such surfaces are STL, IGS STEP, or other geometric extensions known in the prior art.

Volume modeling encompasses the generation of the retention locking mechanism in a 3D CAD medium such as the well-known software Pro-E. The retention locking mechanism is then exported into a CAD medium having the capability to merge the volume solid (as referred to hereafter as a “volume surface”) and the surface of the hearing aid shell. The ability to generate a monolithic hearing aid shell that encompasses an anatomically aligned retention locking mechanism automatically generated in the 3D medium with an ear impression shell surface (cast) created from a polygonized surface of an ear impression forms the basis of the present preferred embodiment. This innovative approach allows a cross-breeding of integration of different casing systems for hearing instrument manufacturing.

A computerized method is provided creating the hybrid shell: 1) a surface shell of a hearing aid is created: and 2) a volume surface (also referred to herein as a “volume model” or “volume solid”) is created for the customizable locking mechanism. This hybrid hearing aid has cumulative attributes of a shell and an earmold. Furthermore, the volume surface generated is utilized as the locking mechanism and is customizable for each individual ear canal.

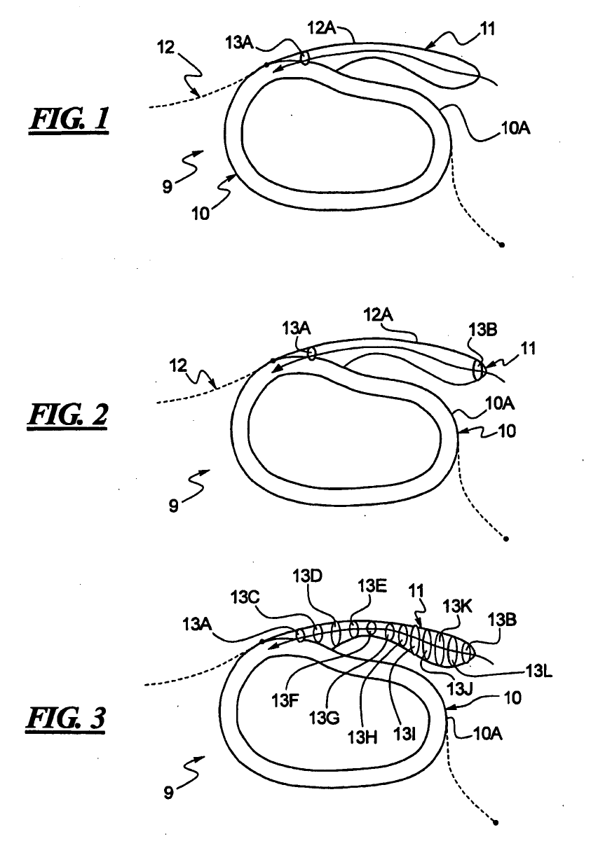

Referring to FIG. 1, a computerized 3D scan conversion implementation provides an overall shell 9 (also known as integrated) comprising: 1) a 3D scan conversion of an extension shape file for the locking mechanism 11 (e.g., an STL file (an STL stereolithography file) is a file type native to the stereolithography CAD software created by 3D Systems of Valencia, Calif. that describes a raw unstructured triangulated surface by the unit normal and vertices, ordered by the right-hand rule of the triangles using a three-dimensional Cartesian coordinate system); and 2) a hearing aid shell 10. Both are located in an ear impression shell surface 12 of a 3D ear impression scan (also known as a cast or an external impression).

In FIGS. 1-3 a first embodiment of the method is shown in which the locking mechanism 11 shown is imported into the software system as an extension part in suitable 3D file formats, including IGES. The extension part can be attached to the shell surface 10A of the hearing aid shell 10 in software or designed as an independent part to be manually affixed to the shell surface 10A as the locking mechanism 11 as part of the post-processing instrument finalization. FIG. 1 shows a defined elliptic profile 13A swept along a locking surface such as the helix curvature portion 12A of the ear impression shell surface 12.

In the case where the geometry of the retention locking mechanism is automatically generated within the software, the 3D modeling software supports the following deformation algorithms: 1) extrusion of a pre-defined 2D profile along a predefined 3D sketch of a spline path defined automatically along the helix or concha (FIG. 1); 2) lofting of the 2D profile along a predefined 3D sketch of a spline path: and 3) lofting together of multiple cross-sectional areas of 2D profiles to generate a 3D shape and therefrom, a final 3D, e.g., STL, file (FIG. 2 and FIG. 3) referred to herein as a “volume surface”, “volume solid” or “volume model”. “Lofting” means generation of a solid by sweeping defined cross-sectional profiles along a defined path.

FIG. 2 shows two defined elliptic profiles 13A, 13B extruded (also known as “lofting” defined above) along the helix portion locking surface 12A of the ear impression shell surface 12; and illustrates a finished integrated (also known as hybrid) shell 9 (e.g., IGES model) with a locking mechanism 11 in place. Here, the formation of the locking mechanism 11 to an ITE (In The Ear) hearing aid shell 10 requires the extraction and lofting of the finished locking mechanism and the shaping of a surface of the locking mechanism for retention.

Also, a formation of the locking mechanism to conform to an ITE ear impression shell surface can be performed with an integrated shell as well. A model of an undetailed ear impression is aligned with an integrated model, and surfaces required for the locking mechanism are transferred to the integrated shell model.

FIG. 3 shows a family of elliptic profiles 13A-13L extruded (lofted) along a profile of the helix curvature portion locking surface 12A of the ear impression shell surface 12.

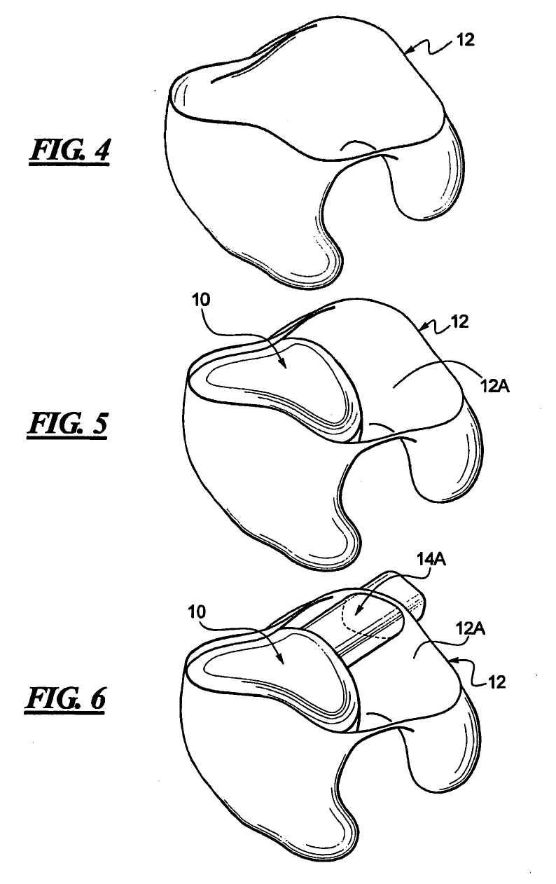

The method and process for development of the locking mechanism 11 according to a second embodiment of the method will be described with respect to FIGS. 4-10.

An ear impression shell surface 12 only is loaded in a computer program with a user interface. As shown in FIG. 4, X, Y, Z data points are triangulated. FIG. 4 thus shows the triangulated ear impression shell surface 12 (also known herein as a “cast” of the physical or scanned ear impression, or an “external ear impression”).

As shown in FIG. 5, the ear impression shell surface 12 and the designed hearing aid shell 10 are aligned. The ear impression shell surface 12 serves as a guide or cast for generating the locking mechanism 11. FIG. 5 shows the external ear impression shell surface 12 with the detailed hearing instrument having the hearing aid shell 10 registered together. The ear impression shell surface 12 serves as a reference cast and provides the profile for generating the locking mechanism 11.

In FIG. 6 the hearing aid shell 10 and a part library feature 14A (also known herein as an “initial shape) used to begin formation of the locking mechanism 11 are merged. This solid part library feature 14A is imported into the CAD software. Thus FIG. 6 shows a hearing aid shell 10 with initial shape 14A inside the ear impression shell surface 12 (with the top portion cut away for viewing ease).

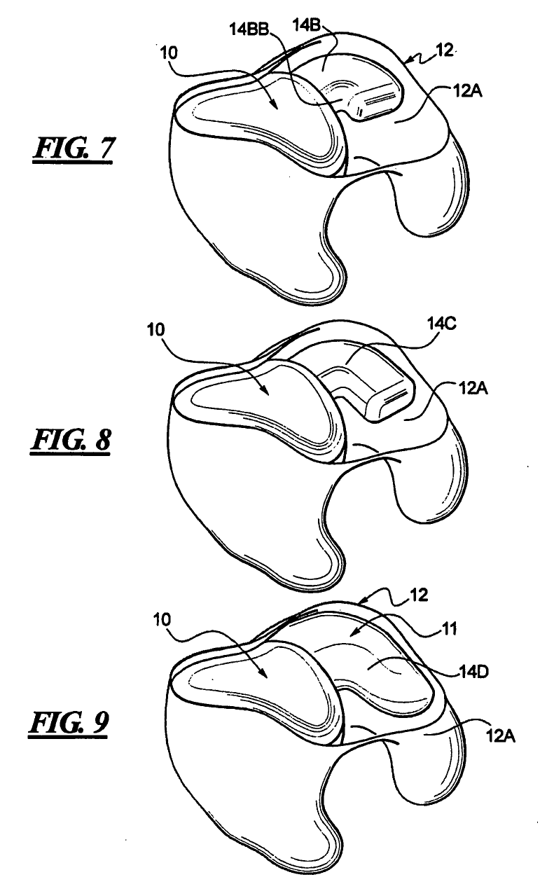

As illustrated in FIG. 6, the initial predefined shape 14A to become the locking mechanism 11 is imported. 3D operations may be performed on the imported initial shape 14A. The locking mechanism initial shape 14A is then aligned with the profile formed by the locking surface 12A such as the helix portion locking surface 12A of the custom ear impression shell surface 12. The locking mechanism initial shape 14A is then bent, extended and stretched as required (see FIGS. 7, 8, and 9) to seat along the helix or concha portion locking surface 12A profile of the ear impression shell surface 12.

The computer program provides the designer with the ability to shape the imported initial geometric shape 14A along a defined axis or using a numerical input to specify a bend angle at bend 14BB (FIG. 7). The bend angle at 14BB is dependent on the shape of the helix or concha portion locking surface 12A profile (FIG. 7). Thus FIG. 7 shows the initial shape 14A undergoing the bending at 14BB along the profile at helix portion locking surface 12A of the external ear impression shell surface 12.

The computer program provides the designer with the ability to shape the imported geometric shape 14A along the profile of the helix or concha portion locking surface 12A. The tip of the helix portion locking surface 12A is the maximum distance that the locking mechanism 11 being formed can extend.

The part library feature as a bent shape 14B along the profile at 12A of the ear shell surface 12 as shown in FIG. 7.

As shown in FIG. 8, the part library feature bent shape 14B is extended along the profile locking surface 12A of the external ear impression shell surface 12 to create the extended bent shape 14C.

As shown in FIG. 9, the part library feature as the extended bent shape 14C is stretched along the profile at 12A of the ear impression shell surface 12 to create the stretched extended bent shape 14D.

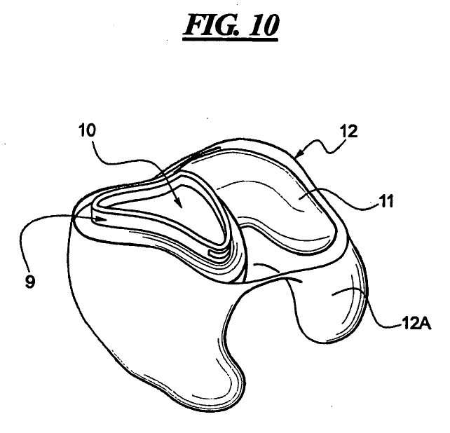

FIG. 10 shows a finalized hearing aid shell 10 (with detail added) with locking mechanism 11 (as an IGES model) forming the hybrid (also known as integrated) shell 9 (as an IGES model) located in the ear impression shell surface 12 (as an IGES model).

While preferred embodiments have been illustrated and described in detail in the drawings and foregoing description, the same are to be considered as illustrative and not restrictive in character, it being understood that only two preferred embodiments have been shown and described and that all changes and modifications that come within the spirit of the invention both now or in the future are desired to be protected.

We claim as our invention:

1. A method for automating design of a locking mechanism for a hearing instrument, comprising the steps of:
providing a computerized 3D file of an ear impression shell surface based on a 3D scan of a 3D ear impression of a patient's ear, said ear impression shell surface including a locking surface comprising at least one of a helix or canal concha portion of the patient's ear;
providing a 3D file of a hearing aid shell;
with a computer, placing the hearing aid shell in a desired location in the ear impression shell surface where the hearing aid shell is to be locked in position; and
with the computer creating a volume surface as a 3D file representing said locking mechanism by utilizing a profile of said ear impression shell surface to be used as said locking surface, said volume surface running from said ear impression shell surface and along said profile as said locking surface.

2. A method of claim 1 wherein said volume surface is created by providing an initial shape and then at least one of bending, extending, and stretching the initial shape into a final shape for said locking mechanism.

3. A method of claim 1 wherein said volume surface is formed by sweeping an elliptic profile from said hearing aid shell surface along said profile at said locking surface.

4. A method for automating design of a locking mechanism for a hearing instrument, comprising the steps of:
providing a computerized 3D file of an ear impression shell surface based on a 3D scan of a 3D ear impression of a patient's ear, said ear impression shell surface including a locking surface comprising at least one of a helix or canal concha portion of the patient's ear;
providing a 3D file of a hearing aid shell;
with a computer, placing the hearing aid shell in a desired location in the ear impression shell surface where the hearing aid shell is to be locked in position; and
with the computer creating a volume surface as a 3D file representing said locking mechanism by sweeping an elliptic profile from said hearing aid shell surface and along a profile of said ear impression shell surface to be used as said locking surface.

5. A method of claim 4 wherein said elliptic profile comprises using a 2D profile to create a resulting 3D curve running centrally along said profile to create said volume surface representing said locking mechanism.

6. A method for automating design of a locking mechanism for a hearing instrument, comprising the steps of:
providing a 3D file of an ear impression shell surface based on a 3D scan of a 3D ear impression of a patient's ear, said ear impression shell surface including a locking surface comprising at least one of a helix or canal concha portion of the patient's ear;
providing a 3D file of a hearing aid shell;
with a computer, placing the hearing aid shell in a desired location in the ear impression shell surface where the hearing aid shell is to be locked in position;
with the computer, importing a 3D file representing an initial shape for the locking mechanism to be connected to the hearing aid shell into the ear impression shell surface and having one end positioned at said hearing aid shell and extending to said locking surface of the ear impression shell surface; and
with the computer, at least one of bending, extending, and stretching the initial shape into a final shape as a 3D file for said locking mechanism by using a profile at said locking surface of the ear impression shell surface.

7. A method of claim 1 wherein said initial shape is first bent, then extended, and then stretched using as a guide said profile of said locking surface of said ear impression shell surface.

8. A method of claim 1 wherein said ear impression shell surface is obtained by acquiring X, Y, Z data from a 3D scanning of a customer ear mold and performing a surface triangulation of said X, Y, Z data wherein closest optimal three points are connected for creating a solid surface.

9. A computer-readable medium comprising a computer program for automating design of a locking mechanism for a hearing instrument, and wherein a computerized 3D file of an ear impression shell surface based on a 3D scan of the 3D ear impression of a patient's ear is provided, said ear impression shell surface including a locking surface comprising at least one of a helix or canal concha portion of the patient's ear, and wherein a 3D file of a hearing aid shell is also provided, said program when in a computer performing the steps of:
placing the hearing aid shell in a desired location in the ear impression shell surface where the hearing aid shell is to be locked in position; and
creating a volume surface is a 3D file representing said locking mechanism by utilizing a profile of said ear impression shell surface to be used as said locking surface, said volume surface running from said ear impression shell surface and along said profile as said locking surface.
